(19) United States
(12) Patent Application Publication
(10) Pub. No.: US 2018/0093524 A1
(43) Pub. Date: Apr. 5, 2018

(54) MECHANICAL PENCIL HAVING A REFILL LEAD CONTAINER

(71) Applicants: Ryo SHIRANE, Saitama Pref (JP); Eiko TANAKA, Chiba Pref (JP); Ryo KAWAMURA, Chiba Pref (JP); Masako OKUYAMA, Tokyo (JP); Rei TAKAHASHI, Kanagawa Pref (JP); Honami YAMAZAKI, Saitam Pref (JP); Koyo USHIKI, Tokyo (JP); Hikaru IKEDA, TOKYO (JP)

(72) Inventors: Ryo SHIRANE, Saitama Pref (JP); Eiko TANAKA, Chiba Pref (JP); Ryo KAWAMURA, Chiba Pref (JP); Masako OKUYAMA, Tokyo (JP); Rei TAKAHASHI, Kanagawa Pref (JP); Honami YAMAZAKI, Saitam Pref (JP); Koyo USHIKI, Tokyo (JP); Hikaru IKEDA, TOKYO (JP)

(21) Appl. No.: 15/834,088

(22) Filed: Dec. 7, 2017

(51) Int. Cl. B43K 21/00

(52) U.S. Cl. CPC B43K 21/003

(57) ABSTRACT

A mechanical pencil includes a main body in which a mechanism for discharging a pencil lead is located, and a clip attached to the main body wherein the clip includes a container for storing a refill for a pencil lead.

### BACKGROUND OF THE INVENTION

### 1. Field of the Invention

This invention has been made by the members of MIMURA Seminar, College of Law, Nihon Univ. as a team. The present invention relates to a mechanical pencil and, more particularly, to a mechanical pencil having a container formed in a clip for storing extra leads.

### 2. Description of the Related Art

In a mechanical pencil of the related art, it is common that the main body of the mechanical pencil and a refill lead case of the mechanical pencil are individual. It can store several extra leads in an inner tube, but it has a limited storage capacity. In daily life, if the refill leads are not accidentally stored in the mechanical pencil at a time of a paper-based examination or at an important meeting, it would be a big problem and it may let all the efforts go down the drain. In order to avoid this problem, it is considered that a refill lead case can be brought in the pencil case. However, it would be bulky, and the refill lead case may be lost because of its small size. Further, in the extra lead case in the related art, the body for storing some refill leads has a single opening for inserting the refills and a cap for covering the opening, which cannot be detached from the body. Thus, when the refill leads are ejected from the body through the opening, it is necessary to turn the extra lead case upside down. In some instance, an unexpected number of the refill lead may be ejected at one time because of the size of the opening and because of the structure thereof, which cannot adjust the volume of the refill leads ejected.

### SUMMARY OF THE INVENTION

It is therefore an object of the invention to resolve the above-described problem. According to our inventions, it is expected that the refill leads can be ejected smoothly in order to avoid getting the refill lead centered on the opening. Further, according to our inventions, it is expected to resolve the problem of the incontinence by carrying both of the refill lead case and the mechanical pencil itself simultaneously. The object is achieved by a mechanical pencil that includes a main body in which a mechanism for discharging a pencil lead is located and a clip attached to the main body wherein the clip includes a container for storing a refill for a lead.

Further, the objective is achieved by a mechanical pencil having a refill container that includes a first opening which is formed on the top of the container and a second opening, which is formed on the bottom of the container.

Moreover, the objective is achieved by a mechanical pencil that further includes a first cap for opening and for closing the first openings and a second cap for opening and for closing the second openings, wherein both of the first and second openings are formed in in the circular shape, and the diameter of the first openings is larger than that of the second openings.

Furthermore, the objective is achieved by a mechanical pencil includes the cap slides in one direction and the second cap slides in the opposite direction of the movement of the first cap.

### BRIEF DESCRIPTION OF THE DRAWINGS

The invention will be more particularly described with reference to the accompanying drawings, in which:

FIG. 1 is a perspective view of a mechanical pencil having a refill lead container according to a preferred embodiment.

FIG. 2A is an enlarged top-plan view of an upper cap of the refill lead container in FIG. 1 in a cap-close state.

FIG. 2B is an enlarged top-plan view of an upper cap of the refill lead container in FIG. 1 in a cap-open state.

FIG. 3A is an enlarged top-plan view of a lower cap of the refill lead container in FIG. 1 in a cap-close state.

FIG. 3B is an enlarged top-plan view of a lower cap of the refill lead container in FIG. 1 in a cap-open state.

FIG. 4A is an enlarged front-plan view of the refill lead container and the upper and lower cap formed in a clip, according to the first embodiment as shown in FIG. 1 in the case that both of the upper and the lower caps are closed.

FIG. 4B is an enlarged front-plan view of the refill lead container and the upper and lower cap formed in a clip, according to the first embodiment as shown in FIG. 1 in the case that the only upper cap only opened.

FIG. 4C is an enlarged front-plan view of the refill lead container and the upper and lower cap formed in a clip, according to the first embodiment as shown in FIG. 1 in the case that the only lower cap opened.

### DETAILED DESCRIPTION OF THE PREFERRED EMBODIMENTS

The preferred embodiment of the invention as to a mechanical pencil 7 having a refill lead container is explained together with drawings as follows. In each drawing, the same reference numbers designate the same or similar components through all embodiments.

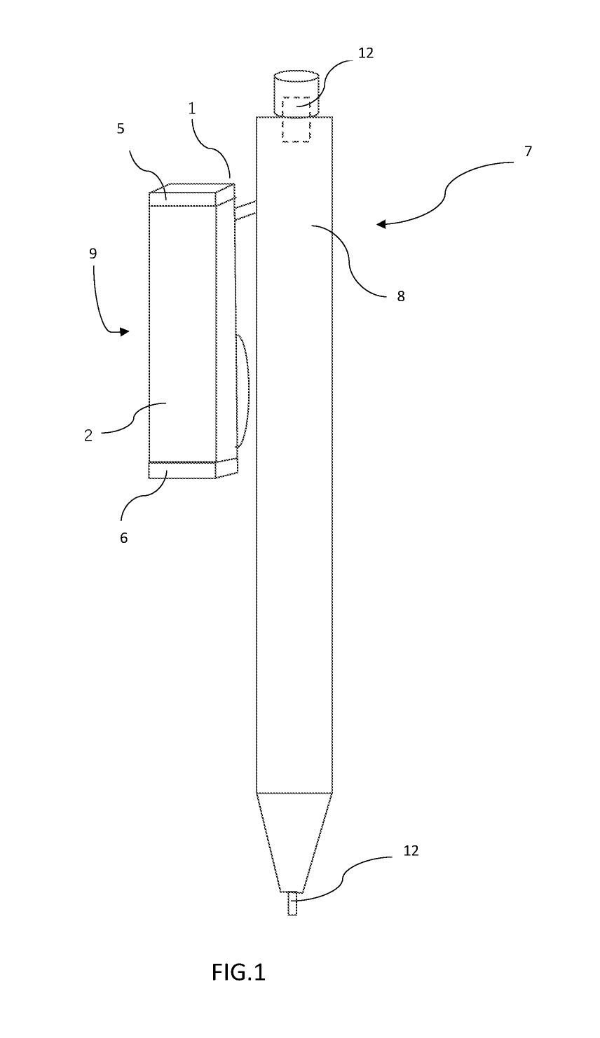

FIG. 1 shows a perspective view of a mechanical pencil of the present invention. The mechanical pencil includes a main body 8 having one end and the other end, a mechanism 11 for discharging a pencil lead from a tip member 12, a clip 9, and a shaft 1 which connects the clip 9 to the main body 8. A pencil lead is inserted from the one end, and the pencil lead is ejected from the other end. As shown in FIG. 1, the shaft 1 is located adjacent to the one end of the main body 8. The main body 8, the clip 9, and the shaft 1 are preferably formed as an integral structure. Alternatively, only the main body 8 and the shaft 1 may be formed as an integral structure, and the shaft 1 and the clip 9 could be connected to each other mechanically or chemically. Furthermore, only the clip 9 and the shaft 1 may be connected to the main body 8 mechanically or chemically. From the viewpoint of strength, it is preferable to make all of these configurations into an integral structure. However, compared with the other components, the shaft 1 is comparatively brittle. When the shaft part 1 is damaged, all parts connected to the shaft part 1 has to be replaced.

Therefore, in view of the economical reasons, and of the easy replacement, it is better to form the shaft 1 and clip 9 integrally. Further, although the shaft 1 is provided on the upper portion of the clip 9 as shown in FIG. 1 in this embodiment, the shaft 1 may be located at the center portion of the side surface of the clip 9.

In the following description the embodiment is described such that the main body 8, the clip 9, and the shaft 1 are formed as a single integral structure, and the shaft 1 is located adjacent to the one end of the main body 8.

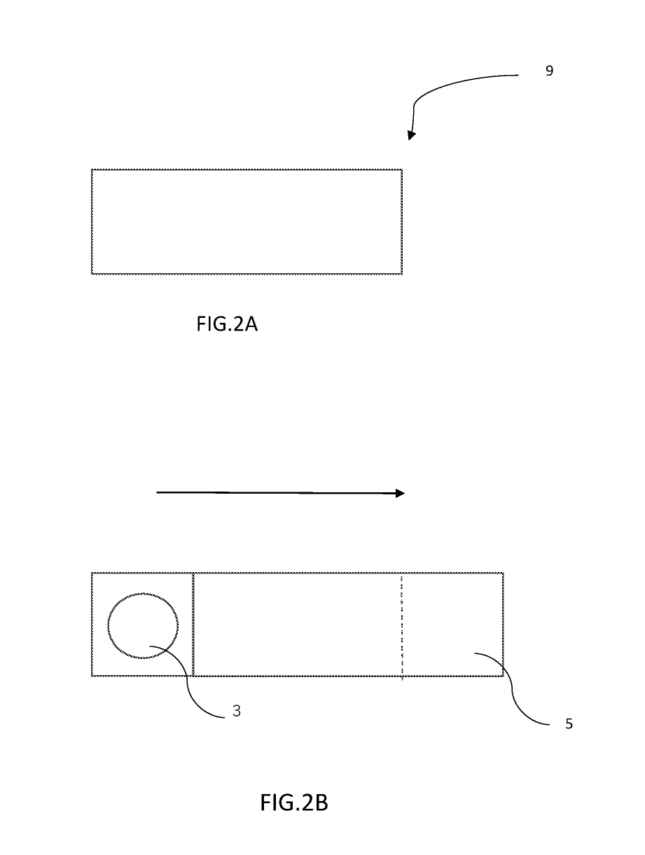

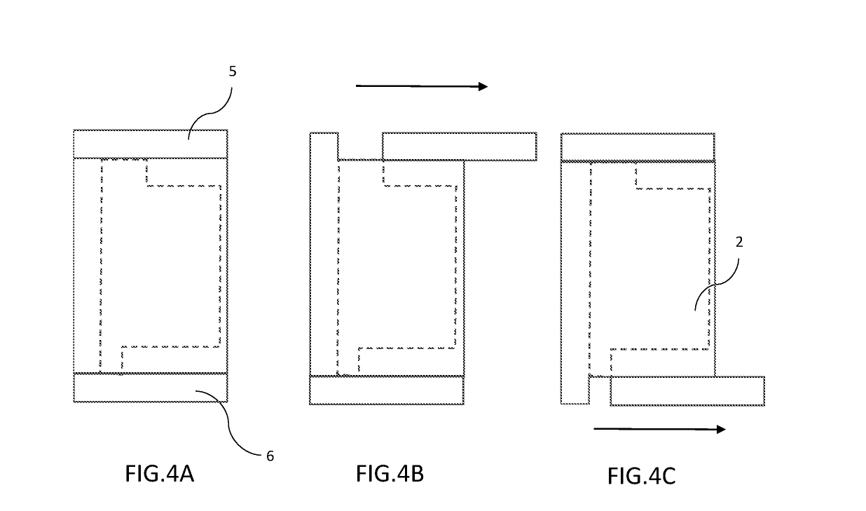

As shown in FIGS. 2A and 2B, the Clip 9 includes a refill lead container 2 for storing pencil lead for the refill therein, a first slide cap 5 attached to top of the refill lead container 2, a second slide cap 6 attached to bottom of the refill lead container 2 The refill lead container has a first opening 3 and a second opening 4. The first opening is formed at the top of the container 2, and the second opening is formed at the bottom of the container 2. The refills for the pencil lead can be placed in the container 2 from the first opening 3, which shows up by sliding the first slide cap 5 to open the lead container 2 while the second slide cap 6 is being closed. As shown FIG. 4B, the first slide cap 5 can be moved toward the main body 8.

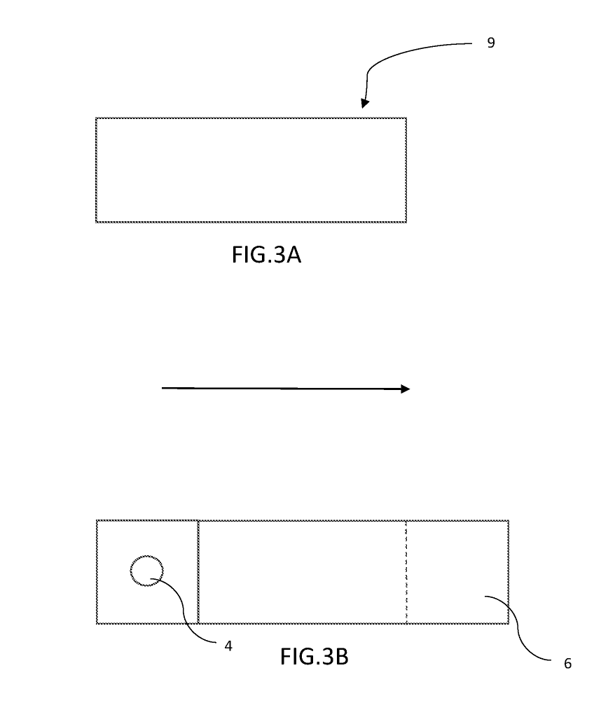

As shown in FIGS. 3A and 3B, the refills for the pencil lead can be ejected from the second opening 4, which shows up by sliding the second slide cap 6 to open the lead container 2. According to this preferred embodiment, although the first cap 5 is moved in the same direction of the movement of the second cap 6, the first cap 5 may be moved in the opposite direction of the movement of the second cap 6. In this case, the second opening 4 is not located just below the first opening. Compare with the first opening 3, a size of the second opening 4 is small. The first and second openings 3 and 4 are formed in circular shape. In order to avoid ejecting many refills for the pencil leads simultaneously, it is preferable to form the second opening 4 having a diameter in the range between 0.6 mm and 0.9 mm in case that the pencil lead having a diameter in 0.5 mm is used. Further, it is preferable to form the first opening 3 whose diameter is larger than that of the second opening 4.

As shown in FIG. 1, the first and second slide caps 5, 6 are in closed state use.

We claim:

1. A mechanical pencil, comprising: a main body in which a mechanism for discharging a pencil lead is located; and a clip attached to the main body wherein the clip includes a container for storing a refill for a pencil lead.

2. A mechanical pencil as claimed in claim 1, wherein the container includes,
(a) a first opening, which is formed on the top of the container;
(b) a second opening, which is formed on the bottom of the container;
(c) a first cap for opening and for closing the first opening; and
(d) a second cap for opening and for closing the second opening,
wherein both the first and second openings are formed in the circular shape, and the diameter of the first opening is larger than that of the second opening.

3. A mechanical pencil as claimed in claim 2, wherein the first cap slides in one direction, and the second cap slides in the opposite direction of the movement of the first cap.

4. A mechanical pencil as claimed in claim 2, wherein the first cap slides in one direction, and the second cap slides in the same direction of the movement of the first cap.

5. A mechanical pencil as claimed in claim 2, further comprising a shaft for connecting the clip to the main body, wherein the clip and the shaft are formed in a single integral structure.

6. A mechanical pencil as claimed in claim 3, further comprising a shaft for connecting the clip to the main body, wherein the clip and the shaft part are formed in a single integral structure.

7. A mechanical pencil as claimed in claim 4, further comprising a shaft for connecting the clip to the main body, wherein the clip and the shaft part are formed in a single integral structure.

8. A mechanical pencil as claimed in claim 2, wherein the first opening and the second opening are formed in circularly shaped, respectively.

9. A mechanical pencil as claimed in claim 3, wherein the first opening and the second opening are formed in circularly shaped, respectively.

10. A mechanical pencil as claimed in claim 2, wherein the diameter of the first opening is formed larger than that of the second opening.

11. A mechanical pencil as claimed in claim 9, wherein the diameter of the first opening is formed larger than that of the second opening.

12. A mechanical pencil as claimed in claim 10, wherein the diameter of the second opening is formed slightly larger than that of a pencil lead being used.

13. A mechanical pencil as claimed in claim 11, wherein the diameter of the second opening is formed slightly larger than that of a pencil lead being used.

14. A mechanical pencil as claimed in claim 10, wherein the diameter of the first opening is formed five times larger than that of a pencil lead being used.

15. A mechanical pencil as claimed in claim 11, wherein the diameter of the first opening is formed five times larger than that of a pencil lead being used.

16. A mechanical pencil as claimed in claim 3, wherein the 1st moveable first cap slides in a direction which is perpendicular to a direction toward the main body.

17. A mechanical pencil as claimed in claim 4, wherein the first cap slides in a direction which is perpendicular to a direction toward the main body.
